(19) United States
(12) Patent Application Publication
(10) Pub. No.: US 2024/0083280 A1
(43) Pub. Date: Mar. 14, 2024

(54) Solar-Power EV Charging System

(71) Applicant: William H. Bender, Norwich, VT (US)

(72) Inventor: William H. Bender, Norwich, VT (US)

(21) Appl. No.: 18/464,720

(22) Filed: Sep. 11, 2023

Related U.S. Application Data
(60) Provisional application No. 63/375,121, filed on Sep. 9, 2022.

(51) Int. Cl. B60L 53/51; B60L 53/30

(52) U.S. Cl. CPC B60L 53/51; B60L 53/30

(57) ABSTRACT

A multi-vehicle self-contained EV charging platform includes: a solar array configured to convert solar energy into an electrical output signal; a charging system configured to receive the electrical output signal from the solar array and generate an EV charging signal; a charge distribution system configured to distribute the EV charging signal amongst a plurality of vehicles if more than one vehicle is coupled to the multi-vehicle self-contained EV charging platform; and a weighted base assembly configured to stabilize the multi-vehicle self-contained EV charging platform.

### RELATED APPLICATION(S)

This application claims the benefit of U.S. Provisional Application No. 63/375,121, filed on 9 Sep. 2022, the entire contents of which are incorporated herein by reference.

### TECHNICAL FIELD

This disclosure relates to solar power EV charging systems and, more particularly, to transportable solar power EV charging systems.

### BACKGROUND

The history of electric vehicle (EV) charging stations dates back to the early development of electric vehicles themselves. Here's an overview of how EV charging stations have evolved over time:
Early 20th Century: Electric vehicles were quite popular in the late 19th and early 20th centuries. During this time, charging was relatively simple and often involved plugging the vehicle into a standard electrical outlet. However, the limited range of these early EVs and advancements in internal combustion engine vehicles led to a decline in electric vehicle popularity.
Mid to Late 20th Century: With the rise of gasoline-powered vehicles and the decline of electric vehicles, charging infrastructure largely disappeared. EVs became niche vehicles used in specific applications like forklifts and golf carts, and these were often charged using on-site industrial charging equipment.
1990s and Early 2000s: Interest in electric vehicles began to grow again due to concerns about environmental issues and dependence on fossil fuels. However, the lack of charging infrastructure remained a significant barrier to widespread adoption. Automakers like General Motors and Toyota introduced electric vehicles with limited availability, and some home charging systems were developed for these vehicles.
Late 2000s to Early 2010s: The launch of the Tesla Roadster in 2008 marked a significant turning point. Tesla invested in building its proprietary Supercharger network, offering high-speed charging exclusively for Tesla vehicles. This helped alleviate “range anxiety” and encouraged other automakers to take charging infrastructure more seriously.
Mid to Late 2010s: Governments and private companies around the world began investing in public charging networks to support the growing adoption of electric vehicles. Various standards emerged for charging connectors and charging levels, such as Level 2 (240V AC charging) and Level 3 (DC fast charging). CHAdeMO and CCS (Combined Charging System) became two of the most common DC fast charging standards.
Present and Future: The electric vehicle market has continued to expand rapidly, with major automakers committing to transitioning their fleets to electric power in the coming years. As a result, the deployment of charging infrastructure has accelerated. Governments, utilities, and private companies are investing in various types of charging stations, including public Level 2 chargers in urban areas, workplace charging, and high-power DC fast charging stations along highways. Wireless charging technology is also being explored as a convenient way to charge EVs.
Innovations: Besides traditional charging stations, innovations like bidirectional charging have emerged. This technology allows electric vehicles to not only draw power from the grid but also send power back, potentially serving as energy storage units during peak demand or emergencies.

Overall, the history of EV charging stations reflects the intertwined development of electric vehicles and the infrastructure needed to support their adoption. As electric vehicle technology advances and becomes more mainstream, the charging infrastructure continues to evolve to meet the demands of a growing electric vehicle market.

But unfortunately, these charging systems typically need to be hardwired to an electrical grid regardless of the manner of charging. This, in turn, results in a charging infrastructure that is difficult to efficiently expand/adjust as needs change.

### SUMMARY OF DISCLOSURE

In one implementation, a multi-vehicle self-contained EV charging platform includes: a solar array configured to convert solar energy into an electrical output signal; a charging system configured to receive the electrical output signal from the solar array and generate an EV charging signal; a charge distribution system configured to distribute the EV charging signal amongst a plurality of vehicles if more than one vehicle is coupled to the multi-vehicle self-contained EV charging platform; and a weighted base assembly configured to stabilize the multi-vehicle self-contained EV charging platform.

One or more of the following features may be included. The charging system may include one or more of: a Level 1 charging system; a Level 2 charging system; and a Level 3 charging system. The charge distribution system configured to distribute the EV charging signal amongst a plurality of vehicles if more than one vehicle is coupled to the multi-vehicle self-contained EV charging platform may be configured to simultaneously provide a portion of the EV charging signal to each of the plurality of vehicles. The charge distribution system configured to distribute the EV charging signal amongst a plurality of vehicles if more than one vehicle is coupled to the multi-vehicle self-contained EV charging platform may be configured to provide the EV charging signal to each of the plurality of vehicles in a round-robin fashion. The weighted base assembly may be configured to be centrally positioned within a 2×2 grid of parking spaces. The weighted base assembly may be a concrete weighted base assembly. The weighted base assembly may be a ballasted base assembly. The ballasted base assembly may be configured to be filled with one or more of: sand; gravel; a liquid; and water. A sun tracking actuation system may be configured to enable the solar array to track the movement of the sun. An inverter system may be configured for converting the electrical output signal from a DC electrical output signal to an AC electrical output signal. An energy storage device may be configured to be charged by the electrical output signal and provide backup energy to the multi-vehicle self-contained EV charging platform.

In another implementation, a multi-vehicle self-contained EV charging platform includes: a solar array configured to convert solar energy into an electrical output signal; a charging system configured to receive the electrical output signal from the solar array and generate an EV charging signal; a charge distribution system configured to distribute the EV charging signal amongst a plurality of vehicles if more than one vehicle is coupled to the multi-vehicle self-contained EV charging platform; and a weighted base assembly configured to stabilize the multi-vehicle self-contained EV charging platform and be centrally positioned within a 2×2 grid of parking spaces.

One or more of the following features may be included. The charging system may include one or more of: a Level 1 charging system; a Level 2 charging system; and a Level 3 charging system. The charge distribution system configured to distribute the EV charging signal amongst a plurality of vehicles if more than one vehicle is coupled to the multi-vehicle self-contained EV charging platform may be configured to simultaneously provide a portion of the EV charging signal to each of the plurality of vehicles. The charge distribution system configured to distribute the EV charging signal amongst a plurality of vehicles if more than one vehicle is coupled to the multi-vehicle self-contained EV charging platform may be configured to provide the EV charging signal to each of the plurality of vehicles in a round-robin fashion. The weighted base assembly may be a concrete weighted base assembly. The weighted base assembly may be a ballasted base assembly. The ballasted base assembly may be configured to be filled with one or more of: sand; gravel; a liquid; and water. A sun tracking actuation system may be configured to enable the solar array to track the movement of the sun. The weighted base assembly may be a concrete weighted base assembly.

In another implementation, a multi-vehicle self-contained EV charging platform includes: a solar array configured to convert solar energy into an electrical output signal; a sun tracking actuation system configured to enable the solar array to track the movement of the sun; a charging system configured to receive the electrical output signal from the solar array and generate an EV charging signal; a charge distribution system configured to distribute the EV charging signal amongst a plurality of vehicles if more than one vehicle is coupled to the multi-vehicle self-contained EV charging platform; and a weighted base assembly configured to stabilize the multi-vehicle self-contained EV charging platform and be centrally positioned within a 2×2 grid of parking spaces.

One or more of the following features may be included. The charging system may include one or more of: a Level 1 charging system; a Level 2 charging system; and a Level 3 charging system. The charge distribution system configured to distribute the EV charging signal amongst a plurality of vehicles if more than one vehicle is coupled to the multi-vehicle self-contained EV charging platform may be configured to simultaneously provide a portion of the EV charging signal to each of the plurality of vehicles. The charge distribution system configured to distribute the EV charging signal amongst a plurality of vehicles if more than one vehicle is coupled to the multi-vehicle self-contained EV charging platform may be configured to provide the EV charging signal to each of the plurality of vehicles in a round-robin fashion. The weighted base assembly may be configured to be centrally positioned within a 2×2 grid of parking spaces. The weighted base assembly may be a ballasted base assembly. The ballasted base assembly may be configured to be filled with one or more of: sand; gravel; a liquid; and water.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a multi-vehicle self-contained EV charging platform;

FIGS. 2-5 are perspective views of the multi-vehicle self-contained EV charging platform of FIG. 1 according to an embodiment of the present disclosure; and

FIGS. 6-7 are diagrammatic views of the multi-vehicle self-contained EV charging platform of FIG. 1 according to an embodiment of the present disclosure.

Like reference symbols in the various drawings indicate like elements.

### DETAILED DESCRIPTION OF THE PREFERRED EMBODIMENTS

System Overview

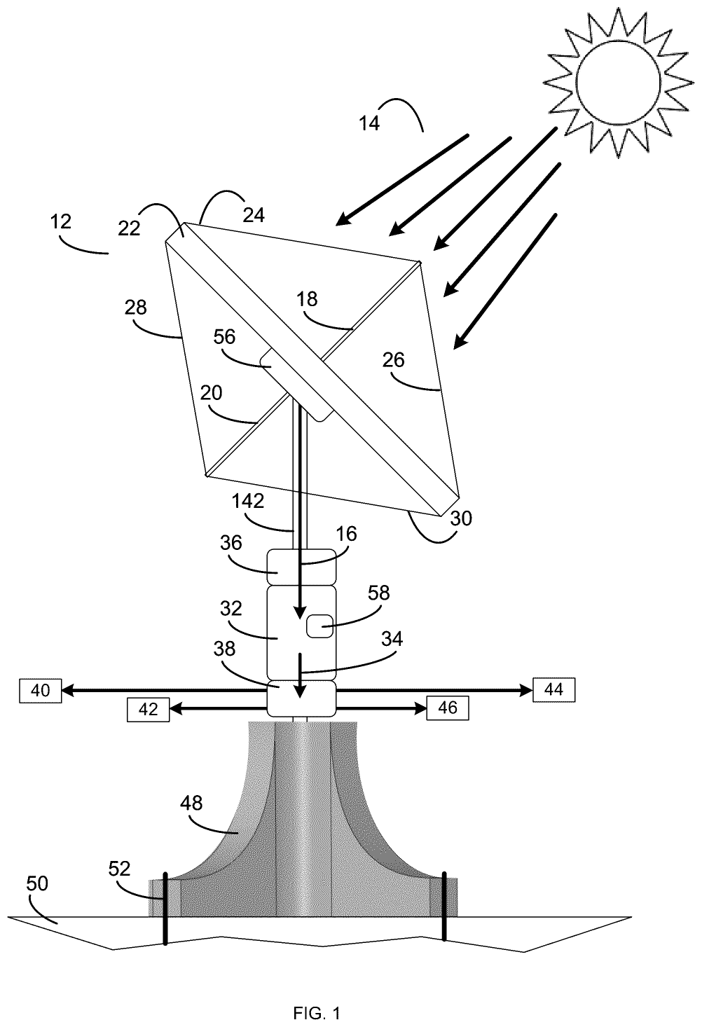

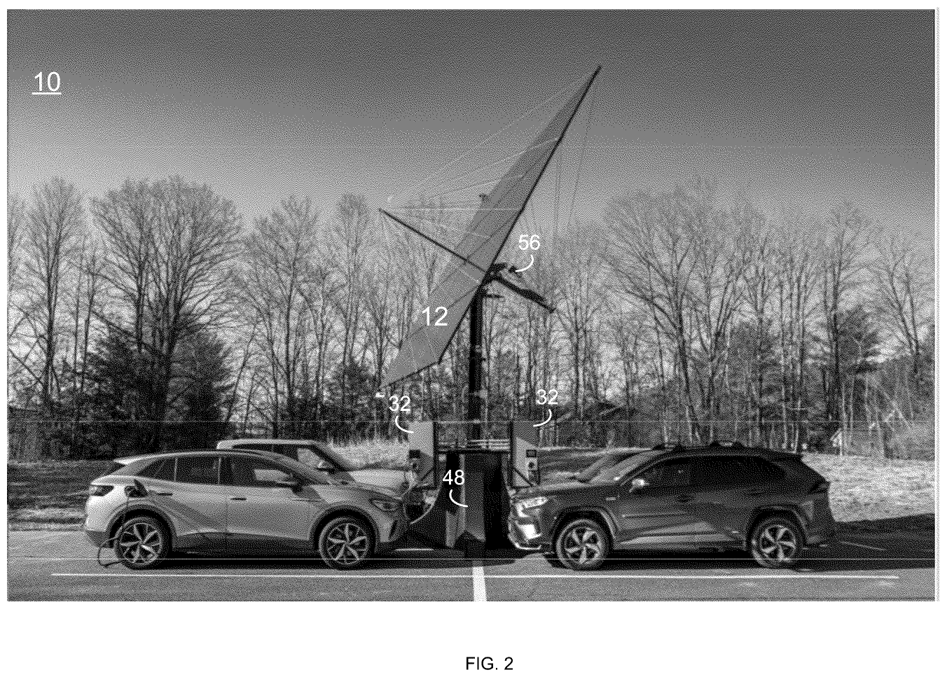

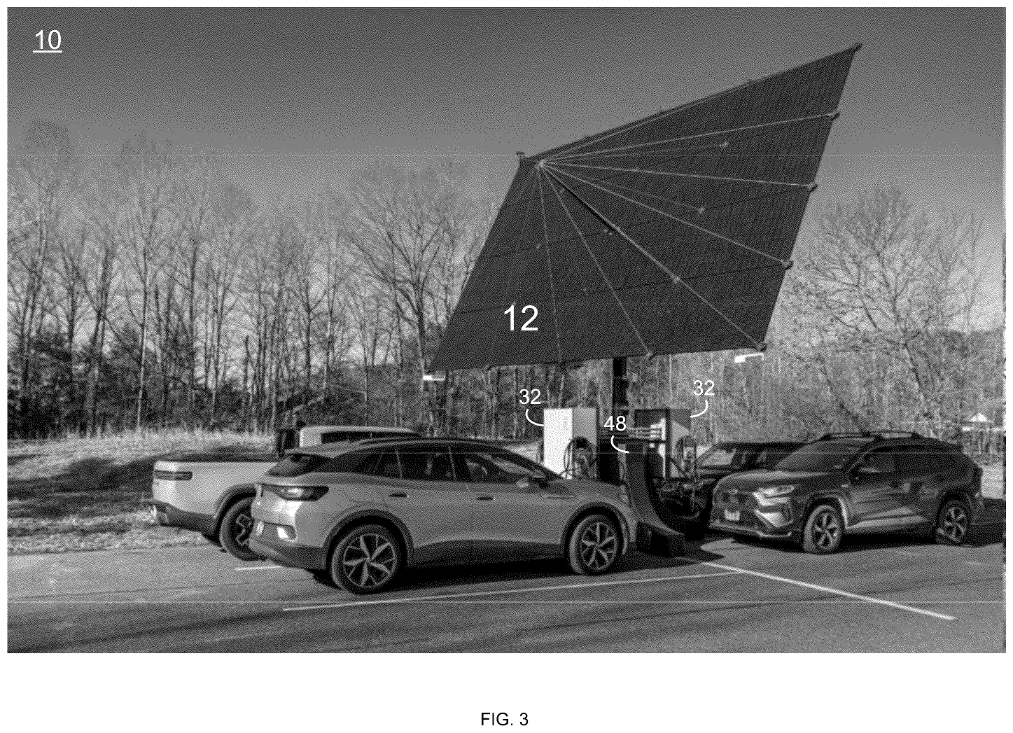

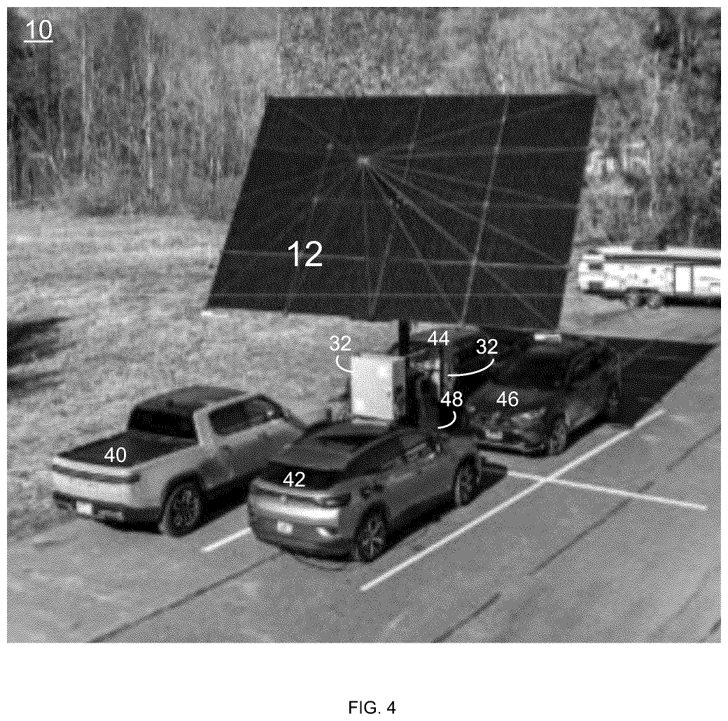

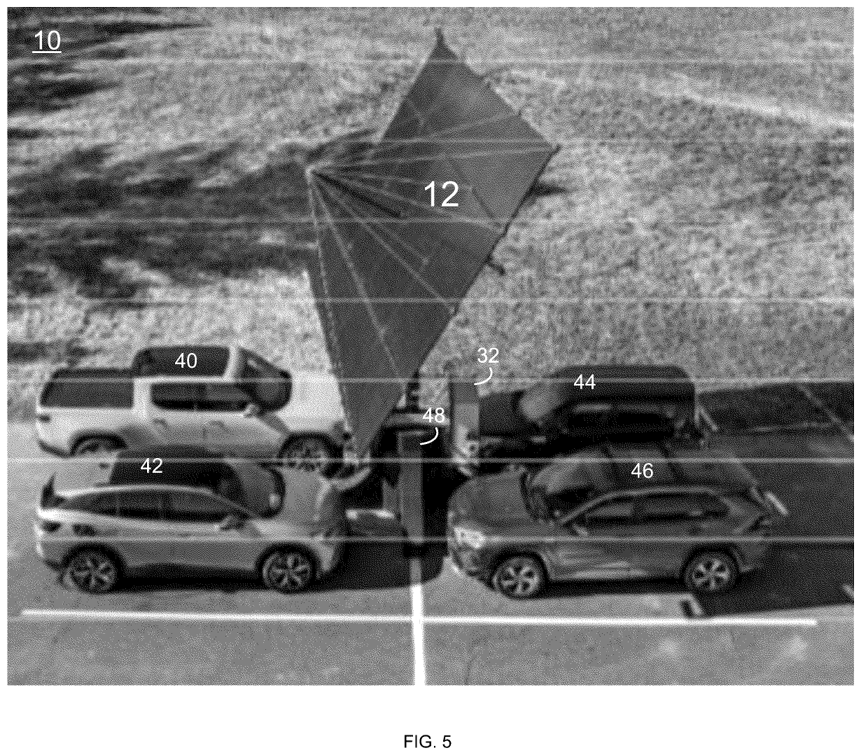

Referring to FIGS. 1-5, there is shown multi-vehicle self-contained EV charging platform 10. As will be explained below in greater detail, multi-vehicle self-contained EV charging platform 10 may be configured to be an off-the-grid multi-vehicle self-contained EV charging platform 10, wherein the energy required to perform such charging operations may be obtained from e.g., solar energy. Being an off-the-grid platform, multi-vehicle self-contained EV charging platform 10 may be easily and quickly installed/removed without the need to engage in lengthy and costly construction projects.

Multi-vehicle self-contained EV charging platform 10 may include a solar array (e.g., solar array 12) configured to convert solar energy (e.g., solar energy 14) into an electrical output signal (e.g., electrical output signal 16).

A solar array (e.g., solar array 12), also known as a solar panel array or photovoltaic array, refers to a grouping or arrangement of multiple solar panels that are designed to capture sunlight (e.g., solar energy 14) and convert it into electricity (e.g., electrical output signal 16) using photovoltaic (PV) technology. Solar arrays (e.g., solar array 12) are a fundamental component of solar power systems and are used to generate clean and renewable energy from the sun's rays.

Specifically, a solar array (e.g., solar array 12) may include a plurality of components, examples of which may include but are not limited to:
Solar Panels: A solar panel is made up of many individual solar cells, typically composed of silicon or other semiconductor materials. When sunlight hits these solar cells, they generate direct current (DC) electricity through the photovoltaic effect.
Solar Inverter: The DC electricity generated by the solar panels needs to be converted into alternating current (AC) electricity, which is the type of electricity used in most homes and businesses. A solar inverter is used to perform this conversion.
Mounting Structure: Solar panels need to be mounted on a stable structure to ensure they are properly oriented toward the sun for maximum efficiency. The mounting structure can be fixed or adjustable, allowing the panels to track the sun's movement throughout the day (tracking systems are more complex but can lead to higher energy output).
Wiring and Connections: The solar panels in an array are wired together in a specific configuration, such as series or parallel connections, to achieve the desired voltage and current levels. The wiring is routed to the inverter and then connected to the building's electrical system or the grid.
Energy Production: As sunlight hits the solar panels, the photons in the sunlight excite electrons in the solar cells, creating a flow of electricity. The solar panels in the array collectively generate electricity, which can be used to power appliances, lights, and other electrical devices.

Solar arrays can vary in size, from small residential installations with just a few panels on a rooftop to large utility-scale installations covering vast areas of land. The amount of electricity a solar array can generate depends on factors like the size of the array, the efficiency of the solar panels, the geographic location, the angle and orientation of the panels, and the amount of sunlight received.

Solar array 12 may include multiple strut rods (e.g., front strut rod 18 and/or rear strut rod 20) that are coupled to guy wires and used to provide structural integrity to solar panels 22. For example, guy wires 24, 26 may be utilized to tension solar panels 22 forward, while guy wires 28, 30 may be utilized to tension solar panels 22 rearward.

Multi-vehicle self-contained EV charging platform 10 may include a charging system (e.g., charging system 32) configured to receive the electrical output signal (e.g., electrical output signal 16) from the solar array (e.g., solar array 12) and generate an EV charging signal (e.g., EV charging signal 34). Examples of the charging system (e.g., charging system 32) may include but are not limited to: a Level 1 charging system; a Level 2 charging system; or a Level 3 charging system.

A Level 1 Charging System refers to the basic and standard method of electric vehicle (EV) charging using a standard household electrical outlet. It's the simplest and slowest way to charge an electric vehicle and typically involves plugging the vehicle into a regular 120-volt AC outlet, similar to the outlets you find in your home for appliances and electronics. Level 1 charging is often used when there is no immediate need for a quick charge, such as when the vehicle is parked overnight at home. However, because Level 1 charging uses standard household power, it tends to be slower compared to higher-level charging options. The charging rate of a Level 1 system is generally limited by the capacity of the standard household outlet, which is usually around 1.4 to 1.9 kilowatts (kW). This translates to an average of 2 to 5 miles of driving range added per hour of charging, depending on the specific EV model. While Level 1 charging is convenient and widely available, it might not be sufficient for drivers with longer commutes or those who need to quickly top up their vehicle's battery.

A Level 2 Charging System is a higher-powered electric vehicle (EV) charging option that offers faster charging times compared to Level 1 charging. It requires a dedicated charging station that is typically installed at homes, workplaces, public parking areas, and other locations where EV owners might need to charge their vehicles. Level 2 charging stations use a 240-volt AC power supply, which is similar to the power used by large home appliances like electric dryers or ovens. Because of the higher voltage and current, Level 2 charging systems can deliver more power to the EV's battery, resulting in faster charging times. The charging rate for Level 2 charging can vary depending on the specific EV and the charging station's power output, but it generally falls in the range of 3.3 kW to 19.2 kW or even higher. This translates to a faster charging rate compared to Level 1 charging, with an average of around 10 to 30 miles of driving range added per hour of charging. Level 2 charging is a convenient option for both residential and commercial charging needs. It provides a good balance between charging speed and infrastructure cost, making it suitable for many EV owners who need to charge their vehicles at home overnight or during the workday.

A Level 3 Charging System, also known as DC fast charging or quick charging, is a high-powered electric vehicle (EV) charging option that offers significantly faster charging times compared to Level 1 and Level 2 charging. Level 3 charging stations provide a convenient and rapid way to charge EVs, especially for drivers on long trips or those who need to quickly recharge their vehicles. Level 3 charging stations use direct current (DC) power instead of alternating current (AC), which allows them to deliver high amounts of power directly to the EV's battery. This results in much faster charging rates compared to Level 1 and Level 2 charging. The exact charging rate can vary depending on the specific charging station and the EV's compatibility. The charging rate of a Level 3 charging system can be quite impressive, ranging from around 50 kW to over 350 kW or more. This translates to adding a substantial amount of driving range in a short amount of time, typically around 60 to 80 miles of range in just 20-30 minutes of charging. Level 3 charging stations are commonly found along highways, in rest areas, and at other high-traffic locations to facilitate long-distance travel for EVs. These stations require specialized equipment and higher infrastructure costs compared to Level 1 and Level 2 charging stations. As a result, they are less common in residential settings and are more often used for public charging networks.

Multi-vehicle self-contained EV charging platform 10 may include an invertersystem (e.g., invertersystem 36) configured for converting the electrical output signal (e.g., electrical output signal 16) from a DC electrical output signal to an AC electrical output signal, as solar array 12 typically provides DC-based power and charging system 32 typically requires AC-based power.

An inverter system is a device that converts direct current (DC) electrical energy into alternating current (AC) electrical energy. Inverters play a crucial role in various applications, including renewable energy systems, electric vehicles, uninterruptible power supplies (UPS), and more. The primary function of an inverter is to enable the use of DC power sources, such as batteries or solar panels, to power devices and appliances that require AC power. The typical operation on an inverter is as follows:
Conversion of DC to AC: In many cases, the power generated by sources like solar panels or stored in batteries is in the form of DC. However, most household appliances and the electrical grid operate on AC. An inverter takes the DC input and converts it into AC output, making it compatible with the devices and the grid.
Waveform: Inverters generate AC power with various waveforms, the most common being sine waves, which closely resemble the smooth waveforms of grid-supplied power. Other types include square waves and modified sine waves, which are less common and might be used in specific applications.
Frequency and Voltage Regulation: Inverters also control the frequency (cycles per second, measured in hertz) and voltage of the AC output. This regulation is important to ensure that the devices connected to the inverter receive stable and appropriate power.

Inverters are used in several applications, such as:
Renewable Energy Systems: Solar panels generate DC power, which is then converted by inverters into AC power suitable for household use or for feeding back into the grid.
Electric Vehicles: Electric vehicles use inverters to convert the DC power stored in their batteries into AC power to drive the vehicle's motor.
Uninterruptible Power Supplies (UPS): Inverters are used in UPS systems to provide backup power during electrical outages, ensuring a continuous power supply to critical devices.
Induction Heating: Inverters can be used for high-frequency induction heating in applications like cooking and metal processing.
Motor Control: In industrial settings, inverters are used to control the speed and direction of AC motors, offering energy efficiency and precise control.
Grid-Tie Systems: In grid-tie solar systems, excess power generated by solar panels can be fed back into the grid using inverters.

Inverters come in various sizes and capacities, depending on the intended application. They vary in terms of efficiency, waveform quality, voltage and frequency regulation, and other features. It's important to choose the right type of inverter for the specific use case to ensure optimal performance and compatibility.

Multi-vehicle self-contained EV charging platform 10 may include a charge distribution system (e.g., charge distribution system 38) configured to distribute the EV charging signal (e.g., EV charging signal 34) amongst a plurality of vehicles (e.g., vehicles 40, 42, 44, 46) if more than one vehicle is coupled to the multi-vehicle self-contained EV charging platform 10. For example and as will be discussed below, charge distribution system 24 may be configured to enable the simultaneous charging of the plurality of vehicles (e.g., vehicles 40, 42, 44, 46).

For example and in one configuration, the charge distribution system (e.g., charge distribution system 38) may be configured to simultaneously provide a portion of the EV charging signal (e.g., EV charging signal 34) to each of the plurality of vehicles (e.g., vehicles 40, 42, 44, 46). For example, assume that charging system 32 is a Level 2 charging system that is configured to provide a 19.2 kW EV charging signal (e.g., EV charging signal 20). Accordingly, charging system 32 may be configured to simultaneous charge the plurality of vehicles (e.g., vehicles 40, 42, 44, 46) by continuously providing each of the plurality of vehicles (e.g., vehicles 40, 42, 44, 46) with a 4.8 kW EV charging signal, resulting in 6-15 miles of range being added to each of the plurality of vehicles (e.g., vehicles 40, 42, 44, 46) per hour of charge time.

For example and in another configuration, the charge distribution system (e.g., charge distribution system 38) may be configured to provide the EV charging signal (e.g., EV charging signal 34) to each of the plurality of vehicles (e.g., vehicles 40, 42, 44, 46) in a round-robin fashion. For example, again assume that charging system 32 is a Level 2 charging system that is configured to provide a 19.2 kW EV charging signal (e.g., EV charging signal 34). Accordingly, charging system 32 may be configured to charge the plurality of vehicles (e.g., vehicles 40, 42, 44, 46) by sequentially providing (e.g., for 15 minutes per hour) a 19.2 kW EV charging signal to each of the plurality of vehicles (e.g., vehicles 40, 42, 44, 46), resulting in 6-15 miles of range being added to each of the plurality of vehicles (e.g., vehicles 40, 42, 44, 46) during each 15 minutes charging period.

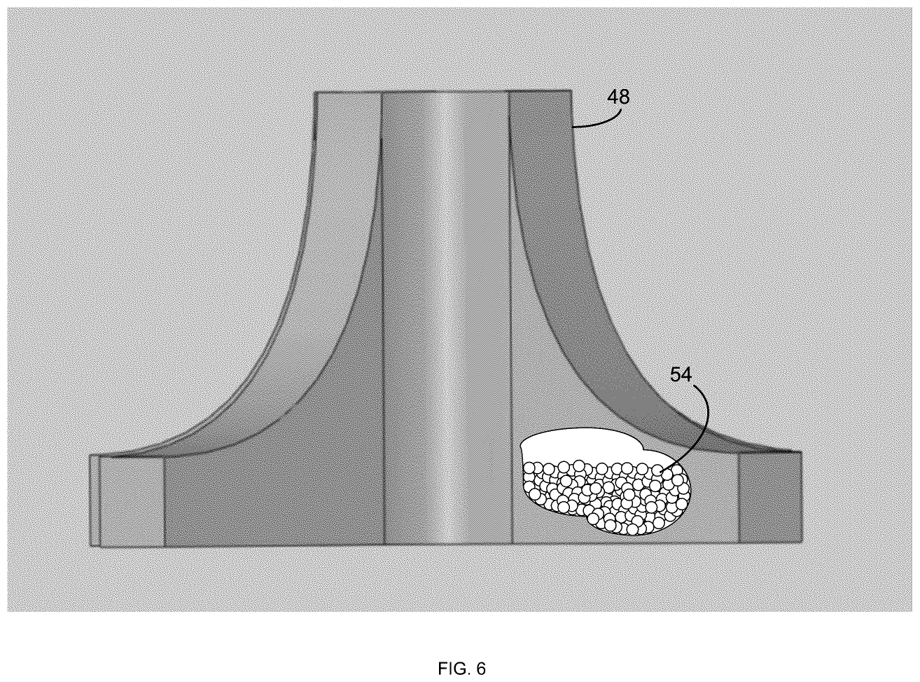

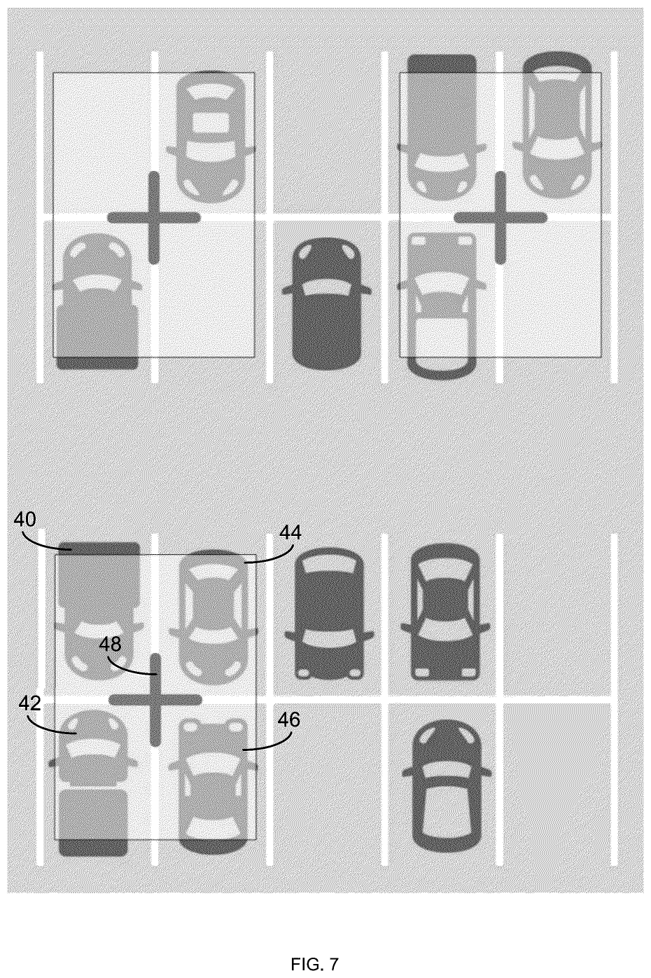

Referring to FIGS. 6-7, multi-vehicle self-contained EV charging platform 10 may include a weighted base assembly (e.g., weighted base assembly 48) configured to stabilize multi-vehicle self-contained EV charging platform 10. The weighted base assembly (e.g., weighted base assembly 48) may be configured to allow for multi-vehicle self-contained EV charging platform 10 to be “easily” moved. For example, weighted base assembly 48 may be of substantial enough mass to prevent undesired movement of multi-vehicle self-contained EV charging platform 10 due to e.g., high winds; yet light enough to allow for movement with the appropriate equipment (such as a boom truck). Depending upon the embodiment, weighted base assembly 48 may be in the range of 8,000-12,000 pounds. Additionally and if needed, weighted base assembly 48 may be pinned to the surface (e.g., surface 50) upon which it is placed (via pins 52 that pass-through passages in the weighted base assembly 48 and into the ground; not shown). Examples of pins 52 may include but are not limited to earth anchors (e.g., PE46-Hex, a 46-inch Penetrator with 2-inch hex head available from American Earth Anchors.

The weighted base assembly (e.g., weighted base assembly 48) may be configured to be centrally positioned within a 2×2 grid of parking spaces. For example, weighted base assembly 48 may be configured in a plus-sign shape, having four legs that are centrally positionable with the four parking spaces (as shown in FIG. 7), thus allowing the charging of the plurality of vehicles (e.g., vehicles 40, 42, 44, 46).

In some implementation, the weighted base assembly (e.g., weighted base assembly 48) may be a concrete weighted base assembly, as concrete may provide substantial enough mass to prevent undesired movement of multi-vehicle self-contained EV charging platform 10.

In another implementation, the weighted base assembly (e.g., weighted base assembly 48) may be a ballasted base assembly. The ballasted base assembly (e.g., weighted base assembly 34) may be configured to be filled with one or more of materials (e.g., materials 54) that may provide the mass necessary to prevent undesired movement of multi-vehicle self-contained EV charging platform 10. Examples of such materials (e.g., materials 54) may include but are not limited to: sand; gravel; water (when utilized in a location that does not experience freezing temperatures) and a liquid (such as salt water when utilized in a location that does experience freezing temperatures). Such a ballasted base assembly (e.g., weighted base assembly 48) may be constructed out of e.g., plastic and may further include structural reinforcing material (such a steel, aluminum, carbon fiber, fiberglass, etc.) to provide the rigidity and/or structural integrity needed to prevent undesired movement of multi-vehicle self-contained EV charging platform 10.

Multi-vehicle self-contained EV charging platform 10 may include a sun tracking actuation system (e.g., sun tracking actuation system 56) configured to enable the solar array (e.g., solar array 12) to track the movement of the sun.

A sun tracking actuation system is a mechanism that allows solar panels or photovoltaic systems to follow the movement of the sun across the sky throughout the day. The goal of a sun tracking actuation system is to maximize the amount of sunlight that the solar panels receive, which in turn increases the efficiency and output of the solar energy generation.

Solar panels are most effective when they are directly facing the sun. As the sun moves from east to west during the day, solar panels that are fixed in one position can only capture a limited amount of sunlight at optimal angles. A sun tracking actuation system adjusts the orientation of the solar panels to ensure they are always facing the sun directly, thereby increasing the amount of sunlight they receive and the energy they can convert.

There are two main types of sun tracking actuation system:
Single-Axis Tracking: This type of tracking system adjusts the solar panels' orientation along a single axis, typically the north-south axis. The panels are tilted either east to west to follow the sun's daily movement. This is a simpler and more common tracking system as it significantly increases energy production compared to fixed panels.
Dual-Axis Tracking: This more complex tracking system adjusts the solar panels along both the elevation (i.e., vertical angle) and east-west axes. This allows the panels to track the sun's movement more precisely, optimizing the angle of incidence for maximum sunlight exposure throughout the day and year. Dual-axis tracking systems can be particularly beneficial in locations with high latitudes or varying seasonal sun angles.

Solar tracking systems can be implemented using various technologies, such as:
Active Tracking: This involves using motors, gears, and sensors to actively adjust the solar panels' orientation in real-time as the sun moves. Active tracking systems can be powered by electricity or controlled by computer algorithms.
Passive Tracking: Passive tracking systems use mechanical design and gravitational forces to naturally align the solar panels with the sun's position. These systems are generally simpler and do not require external power sources.

While solar tracking systems can significantly enhance energy production, they also come with some drawbacks. They are more complex to design, install, and maintain compared to fixed solar panels. They also incur higher upfront costs due to the added components and mechanisms. The benefits and feasibility of using a solar tracking system depend on factors such as location, available space, budget, and desired energy output.

Multi-vehicle self-contained EV charging platform 10 may include an energy storage device (e.g., energy storage device 58) configured to be charged by the electrical output signal (e.g., electrical output signal 16) and provide backup energy to multi-vehicle self-contained EV charging platform 10. Examples of energy storage device 58 may include but are not limited to a lithium-ion battery or lead acid battery. As discussed above, the sun moves from east to west during the day and sun tracking actuation system 56 may be configured to move the solar panels (e.g., solar array 12) from east to west during the day. Therefore and at the end of the day, the solar panels (e.g., solar array 12) may be facing west and will need to be repositioned to face east prior to sunrise the next day. Accordingly, energy storage device 58 may provide sun tracking actuation system 56 with the electrical energy required to reposition the solar panels (e.g., solar array 12) and to provide EV charging when there is limited availability of sunlight (e.g., night).

General

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed Is:

1. A multi-vehicle self-contained EV charging platform comprising:
a solar array configured to convert solar energy into an electrical output signal;
a charging system configured to receive the electrical output signal from the solar array and generate an EV charging signal;
a charge distribution system configured to distribute the EV charging signal amongst a plurality of vehicles if more than one vehicle is coupled to the multi-vehicle self-contained EV charging platform; and
a weighted base assembly configured to stabilize the multi-vehicle self-contained EV charging platform.

2. The multi-vehicle self-contained EV charging platform of claim 1 wherein the charging system includes one or more of:
a Level 1 charging system;
a Level 2 charging system; and
a Level 3 charging system.

3. The multi-vehicle self-contained EV charging platform of claim 1 wherein the charge distribution system configured to distribute the EV charging signal amongst a plurality of vehicles if more than one vehicle is coupled to the multi-vehicle self-contained EV charging platform is configured to simultaneously provide a portion of the EV charging signal to each of the plurality of vehicles.

4. The multi-vehicle self-contained EV charging platform of claim 1 wherein the charge distribution system configured to distribute the EV charging signal amongst a plurality of vehicles if more than one vehicle is coupled to the multi-vehicle self-contained EV charging platform is configured to provide the EV charging signal to each of the plurality of vehicles in a round-robin fashion.

5. The multi-vehicle self-contained EV charging platform of claim 1 wherein the weighted base assembly is configured to be centrally positioned within a 2×2 grid of parking spaces.

6. The multi-vehicle self-contained EV charging platform of claim 1 wherein the weighted base assembly is a concrete weighted base assembly.

7. The multi-vehicle self-contained EV charging platform of claim 1 wherein the weighted base assembly is a ballasted base assembly.

8. The multi-vehicle self-contained EV charging platform of claim 7 wherein the ballasted base assembly is configured to be filled with one or more of:
sand;
gravel;
a liquid; and
water.

9. The multi-vehicle self-contained EV charging platform of claim 1 further comprising:
a sun tracking actuation system configured to enable the solar array to track the movement of the sun.

10. The multi-vehicle self-contained EV charging platform of claim 1 further comprising:
an inverter system configured for converting the electrical output signal from a DC electrical output signal to an AC electrical output signal.

11. The multi-vehicle self-contained EV charging platform of claim 1 further comprising:
an energy storage device configured to be charged by the electrical output signal and provide backup energy to the multi-vehicle self-contained EV charging platform.

12. A multi-vehicle self-contained EV charging platform comprising:
a solar array configured to convert solar energy into an electrical output signal;
a charging system configured to receive the electrical output signal from the solar array and generate an EV charging signal;
a charge distribution system configured to distribute the EV charging signal amongst a plurality of vehicles if more than one vehicle is coupled to the multi-vehicle self-contained EV charging platform; and
a weighted base assembly configured to stabilize the multi-vehicle self-contained EV charging platform and be centrally positioned within a 2×2 grid of parking spaces.

13. The multi-vehicle self-contained EV charging platform of claim 12 wherein the charging system includes one or more of:
a Level 1 charging system;
a Level 2 charging system; and
a Level 3 charging system.

14. The multi-vehicle self-contained EV charging platform of claim 12 wherein the charge distribution system configured to distribute the EV charging signal amongst a plurality of vehicles if more than one vehicle is coupled to the multi-vehicle self-contained EV charging platform is configured to simultaneously provide a portion of the EV charging signal to each of the plurality of vehicles.

15. The multi-vehicle self-contained EV charging platform of claim 12 wherein the charge distribution system configured to distribute the EV charging signal amongst a plurality of vehicles if more than one vehicle is coupled to the multi-vehicle self-contained EV charging platform is configured to provide the EV charging signal to each of the plurality of vehicles in a round-robin fashion.

16. The multi-vehicle self-contained EV charging platform of claim 12 wherein the weighted base assembly is a concrete weighted base assembly.

17. The multi-vehicle self-contained EV charging platform of claim 12 wherein the weighted base assembly is a ballasted base assembly.

18. The multi-vehicle self-contained EV charging platform of claim 17 wherein the ballasted base assembly is configured to be filled with one or more of:
sand;
gravel;
a liquid; and
water.

19. The multi-vehicle self-contained EV charging platform of claim 12 further comprising:
a sun tracking actuation system configured to enable the solar array to track the movement of the sun.

20. The multi-vehicle self-contained EV charging platform of claim 12 wherein the weighted base assembly is a concrete weighted base assembly.

21. A multi-vehicle self-contained EV charging platform comprising:
a solar array configured to convert solar energy into an electrical output signal;
a sun tracking actuation system configured to enable the solar array to track the movement of the sun;
a charging system configured to receive the electrical output signal from the solar array and generate an EV charging signal;
a charge distribution system configured to distribute the EV charging signal amongst a plurality of vehicles if more than one vehicle is coupled to the multi-vehicle self-contained EV charging platform; and
a weighted base assembly configured to stabilize the multi-vehicle self-contained EV charging platform and be centrally positioned within a 2×2 grid of parking spaces.

22. The multi-vehicle self-contained EV charging platform of claim 21 wherein the charging system includes one or more of:
a Level 1 charging system;
a Level 2 charging system; and
a Level 3 charging system.

23. The multi-vehicle self-contained EV charging platform of claim 21 wherein the charge distribution system configured to distribute the EV charging signal amongst a plurality of vehicles if more than one vehicle is coupled to the multi-vehicle self-contained EV charging platform is configured to simultaneously provide a portion of the EV charging signal to each of the plurality of vehicles.

24. The multi-vehicle self-contained EV charging platform of claim 21 wherein the charge distribution system configured to distribute the EV charging signal amongst a plurality of vehicles if more than one vehicle is coupled to the multi-vehicle self-contained EV charging platform is configured to provide the EV charging signal to each of the plurality of vehicles in a round-robin fashion.

25. The multi-vehicle self-contained EV charging platform of claim 21 wherein the weighted base assembly is configured to be centrally positioned within a 2×2 grid of parking spaces.

26. The multi-vehicle self-contained EV charging platform of claim 21 wherein the weighted base assembly is a ballasted base assembly.

27. The multi-vehicle self-contained EV charging platform of claim 26 wherein the ballasted base assembly is configured to be filled with one or more of:
sand;
gravel;
a liquid; and
water.
